(19) United States
(12) Patent Application Publication
(10) Pub. No.: US 2018/0270537 A1
(43) Pub. Date: Sep. 20, 2018

(54) ASPECTS PERTAINING TO BINGE WATCHING OF CONTENT BY A VIEWER

(71) Applicant: THOMSON Licensing, Issy-les-Moulineaux (FR)

(72) Inventors: Brian ERIKSSON, San Jose, CA (US); Jean C. BOLOT, Los Altos, CA (US); Azin ASHKAN, San Jose, CA (US)

(21) Appl. No.: 15/763,607

(22) PCT Filed: Sep. 30, 2015
(86) PCT No.: PCT/US2015/053294

§ 371 Date: Mar. 27, 2018

(51) Int. Cl. H04N 21/466; H04N 21/45; H04N 21/442

(52) U.S. Cl. CPC H04N 21/4668; H04N 21/44222; H04N 21/44204; H04N 21/4532

(57) ABSTRACT

Various methods, apparatuses, and computer-readable medium are described herein. A device (1002) may provide a content recommendation (310) to a viewer based on a profile (202) of the viewer. The device (1002) may also detect binge watching of the recommended content (310) by the viewer. The device (1002) may also limit further viewing of the recommended content (310) in response to detecting the binge watching. In response to the binge watching, the device (1002) may also provide a message (402) to the viewer, provide a suggestion (404) to the viewer of content, and/or provide an incentive (406) to the viewer to perform another activity. The device (1002) may detect binge watching by detecting that a consumption rate (304) of the recommended content (310) by the viewer exceeds a threshold consumption rate (306) of the recommended content (310).

### TECHNICAL FIELD

The present disclosure, generally, relates to providing content to a viewer and, more specifically, relates to aspects pertaining to binge watching of content by a viewer.

### INTRODUCTION

Some content providers such as NETFLIX and HBO GO give viewers unlimited access to content based on subscription fees or the purchase of such content. In some cases, such content can be streamed or downloaded via the Internet. Because viewers have unlimited access to content, viewers may sometimes engage in binge watching. Binge watching may refer to unusually long periods of content viewing. For example, viewers may watch many episodes of a show back-to-back with minimal interruption between each episode. Some media systems automatically begin a subsequent episode following a preceding episode, without any viewer input, which can increase the tendency of the viewer to engage in binge watching. Although viewers sometimes engage in binge watching, binge watching may be undesirable under certain circumstances. While binge watching, the viewer is highly engaged with the media system. However, after the binge watching is complete, the viewer is highly disengaged from the media system. Accordingly, the viewer's engagement with the media system fluctuates between two extremes when binge watching is unregulated. Furthermore, the viewer may not fully realize the substantial amount of time consumed for binge watching. Accordingly, viewers may benefit from enhancements that reduce any undesirable effects associated with binge watching and improve the content viewing experience.

### SUMMARY OF SOME EMBODIMENTS

Various aspects of methods, apparatuses, and computer-readable medium are described throughout the present disclosure. The following description provides various non-limiting examples and is not intended to limit the scope of the present disclosure.

In an aspect, the present disclosure provides a method of providing content to a viewer. The method may include providing a content recommendation to a viewer based on a profile of the viewer. The method may also include detecting binge watching of recommended content by the viewer. The method may also include limiting further viewing of the recommended content by the viewer in response to detecting the binge watching.

In another aspect, the present disclosure provides an apparatus for providing content to the viewer. The apparatus may include at least one processor. The apparatus may also include a memory containing a set of instructions when executed by the at least one processor perform operations that may include providing a content recommendation to the viewer based on a profile of the viewer. The operations may also include detecting binge watching of recommended content by the viewer. The operations may also include limiting further viewing of the recommended content by the viewer in response to detecting the binge watching.

In yet another aspect, the present disclosure provides another apparatus for providing content to the viewer. The apparatus may include means for providing a content recommendation to a viewer based on a profile of the viewer. The apparatus may also include means for detecting binge watching of recommended content by the viewer. The apparatus may also include means for limiting further viewing of the recommended content by the viewer in response to detecting the binge watching.

In a further aspect, the present disclosure provides a computer-readable medium comprising computer-executable code for providing a content recommendation to a viewer based on a profile of the viewer. The computer-executable code may be further for detecting binge watching of recommended content by the viewer. The computer-executable code may be further for limiting further viewing of the recommended content by the viewer in response to detecting the binge watching.

The foregoing is merely a summary of various features described in greater detail herein. Additional features are also described herein. The embodiments described herein may be implemented in any combination or sub-combination, even if not explicitly described herein. These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures.

### BRIEF DESCRIPTION OF DRAWINGS

FIG. 1 is a diagram illustrating an example of a server device in communication with various client devices.

FIG. 2 is a diagram illustrating an example of a client device providing a profile of a viewer to the server device.

FIG. 3 is a diagram illustrating an example of the server device providing content to the client device based on the profile of the viewer.

FIG. 4 is a diagram illustrating an example of various operations performed in response to detecting binge watching by the viewer.

FIGS. 5-9 are diagrams illustrating examples of various methods and/or processes performed by the server device and/or client device.

FIG. 10 is a diagram illustrating an example of a hardware implementation of the server device and/or client device.

### DESCRIPTION OF SOME EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

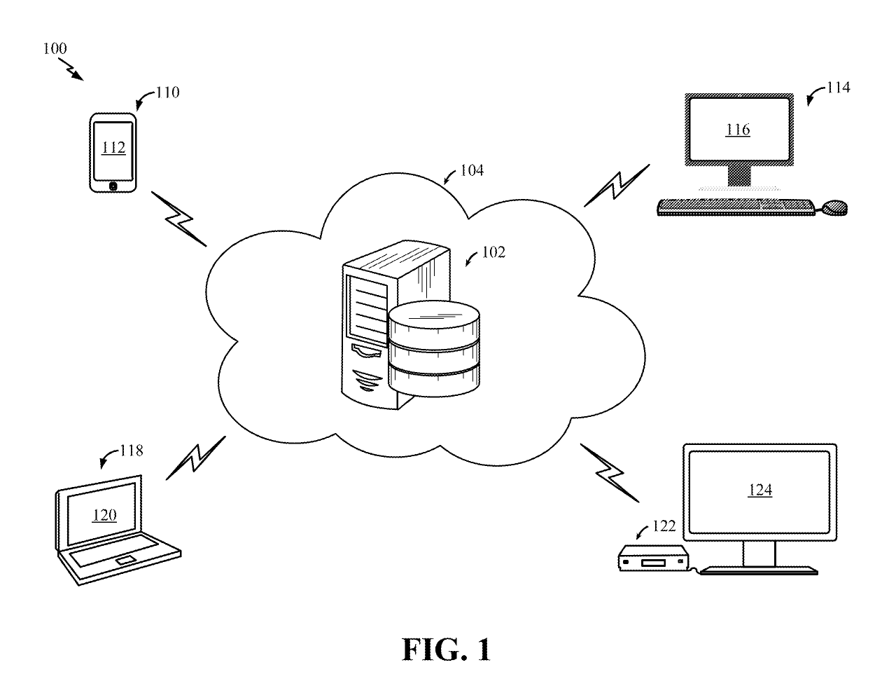

FIG. 1 is a diagram 100 illustrating an example of a server device in communication with various client devices according to various aspects of the present disclosure. For illustrative purposes, the server device may be a server 102. For illustrative purposes, a number of client devices are shown in FIG. 1. For example, client devices may include a phone 110, a desktop computer 114, a laptop computer 118, and a set top box 122. Each client device may be connected or otherwise communicatively coupled to a display. For example, the phone 110 may have a built-in display 112, the desktop computer 114 may be connected to an external display 116, the laptop computer 118 may have a built-in display 120, and the set top box may be connected to a display 124. Although not illustrated in FIG. 1, alternative examples of client devices may include tablet computers, wearable devices (e.g., glasses, watches, etc.), and various other suitable devices. Although the non-limiting example illustrated in FIG. 1 shows four client devices, one of ordinary skill in the art will also understand that any number of client devices may be implemented without deviating from the scope of the present disclosure.

The server device may be located locally (e.g., within the same network and/or physical location) or remotely (e.g., within a different network and/or physical location) in relation to the client devices. For example, the server device may be associated with an Internet-based (e.g., “cloud”-based) computing environment 104. Communications between the client devices and the server device may be performed via a wired connection and/or a wireless connection. Such communications may be performed using various types of technologies without deviating from the scope of the present disclosure. One of ordinary skill in the art will understand that various types of communication technologies may be used without deviating from the scope of the present disclosure. Without deviating from the scope of the present disclosure, such communications may be facilitated by various other computers, servers, gateways, routers, and other hardware devices, even if not illustrated in FIG. 1.

In some configurations, the server device may communicate with one or more of the client devices via any suitable wired and/or wireless network. For example, the wireless network may include a wireless local area network (WLAN), such as a network that implement protocols and/or algorithms that comply with various communication standards of the Institute of Electrical and Electronics Engineers (IEEE), such as IEEE 802.11. As another example, the wireless network may be a cellular network that implements protocols and/or algorithms that comply with various communication standards of the Third Generation Partnership Project (3GPP) and 3GPP2, such as 3G and 4G (Long Term Evolution), and/or of the Next Generation Mobile Networks (NGMN) Alliance, such as 5G.

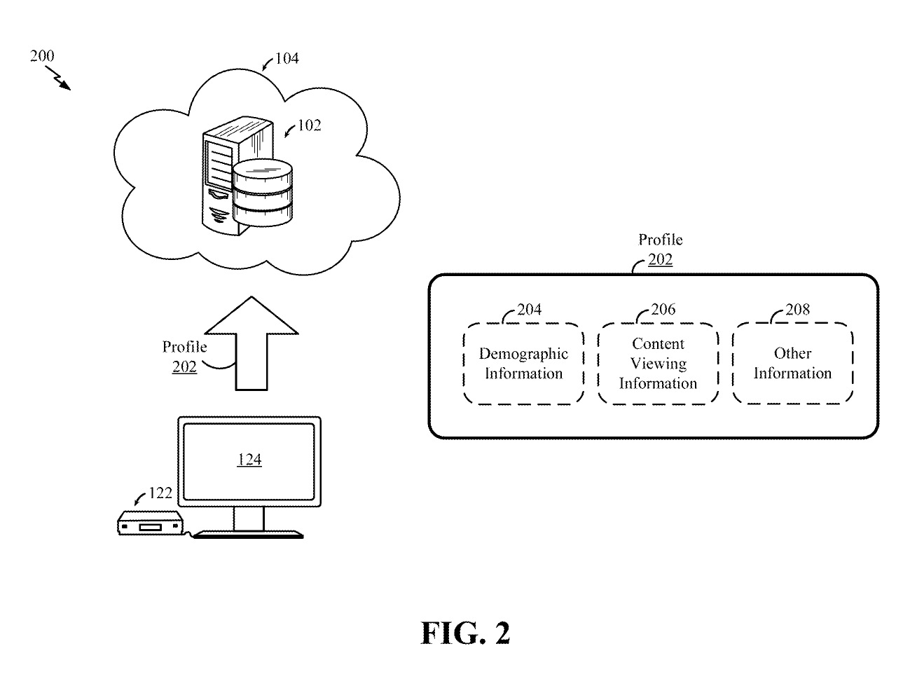

FIG. 2 is a diagram 200 that illustrates an example of a client device (e.g., set top box 122) providing a profile 202 of a viewer to the server device (e.g., server 102). Generally, the profile 202 of the viewer may include various types of information associated with the viewer and/or viewing patterns/behaviors of the viewer without deviating from the scope of the present disclosure. In some configurations, the profile 202 may include demographic information 204 associated with the viewer. Demographic information 204 may include the age, gender, geographic location, personal/household income, occupation, ethnicity, language(s), marital status, religious affiliation, and/or other information associated with the viewer. The demographic information 204 may be provided from various sources without deviating from the scope of the present disclosure. In some configurations, the viewer may provide at least some of the demographic information 204. In some configurations, at least some of the demographic information 204 may be retrieved, queried, and/or otherwise obtained from a database (e.g., a database that stores census data).

In some configurations, the profile 202 may include content viewing information 206 associated with the viewer. Generally, content viewing information 206 includes any information that pertains to the content viewing patterns and/or habits of the viewer. As a first example, the content viewing information 206 may include the genres, subjects, and/or categories that the viewer has previously watched as well as the duration that the viewer has watched such genres, subjects, and/or categories. As a second example, the content viewing information 206 may include the preferences, selections, choices, options, and/or interests of the viewer.

As a third example, the content viewing information 206 may include the viewer's rate of content consumption. The viewer's rate of content consumption may sometimes also be referred to as the viewer's velocity of content consumption without deviating from the scope of the present disclosure. Generally, the concept of ‘rate’ (or, ‘velocity’) refers to the amount of time that the viewer spends viewing content over a particular period of time. In other words, this concept can refer to the ratio of (i) the amount of time that the viewer spends viewing content divided by (ii) a total amount of time. For instance, a viewer that spends eight hours viewing content during a twenty-four hour period of time has a higher rate (or, velocity) of content consumption relative to another viewer that spends four hours viewing content during that twenty-four hour period of time.

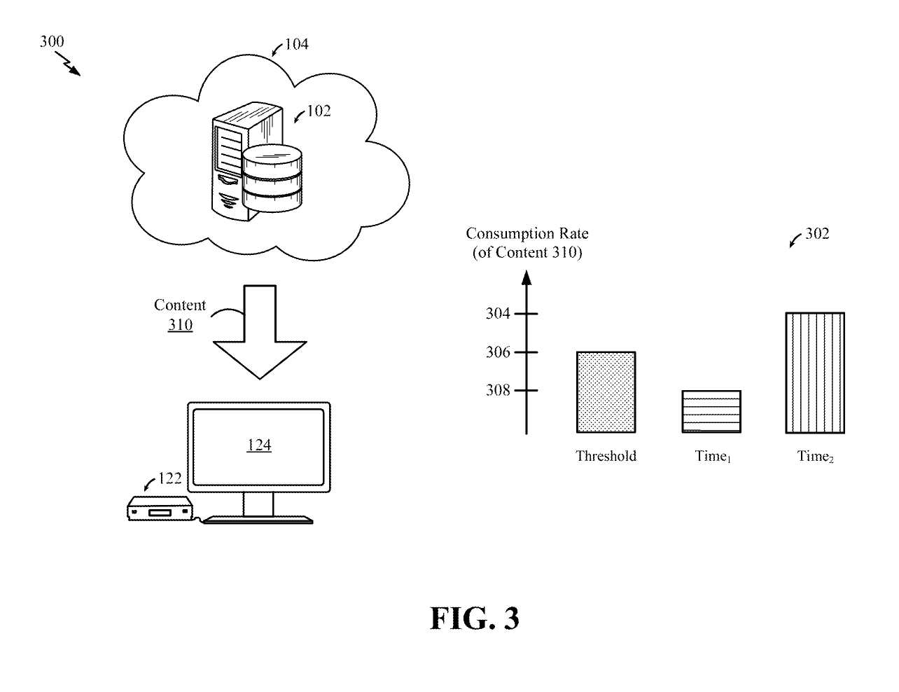

As a fourth example, the content viewing information 206 may include indicators associated with the viewer's tendency to engage in binge watching. Generally, ‘binge watching’ refers to the activity of viewing content for a prolonged, abnormal, and/or otherwise unusually long duration of time. The viewer may engage in binge watching by viewing content at a rate (or, velocity) that exceeds a threshold consumption rate 306 (from FIG. 3 to be explained below) for viewing content. For example, the viewer may watch many episodes of a particular show with minimal interruption between each episode. In other words, binge watching may consist of watching a certain number of episodes of a particular show during a single viewing session. A viewing session may refer to a period of time during which the viewer is engaged in watching content for all (or, substantially all) of the time (with the possible exception of a few brief interruptions or breaks). However, binge watching is not limited to many episodes of a single show. For example, the viewer may engage in binge watching by viewing a high number of episodes of different shows. Binge watching may also be referred to as binge-viewing, marathon-viewing, and other suitable terms without deviating from the scope of the present disclosure. Additional description pertaining to binge-watching is provided herein. If the viewer has recently engaged in binge watching, the content viewing information 206 may include indicators that indicate that the viewer has a tendency to engage in binge watching.

Various non-limiting examples of information included in the profile 202 are provided herein. However, one of ordinary skill in the art will understand that the profile 202 of the viewer may include other information 208 such as demographic, preference, and other types of information without deviating from the scope of the present disclosure. Such other information 208 in the profile 202 may include any type of information associated with the viewer without deviating from the scope of the present disclosure. Additionally, one of ordinary skill in the art will also understand that the concepts described herein with reference to a single viewer may be extrapolated to apply to a plurality of viewers without deviating from the scope of the present disclosure.

FIG. 3 is a diagram 300 illustrating an example of the server device (e.g., server 102) providing content 310 to the client device (e.g., set top box 122) based on the profile 202 of the viewer. The profile 202 of the viewer is described in greater detail with reference to FIG. 1 and therefore will not be repeated. Based on the profile 202 of the viewer, the server 102 provides one or more recommendations of content 310 to the viewer. For example, the demographic information 204 of the profile 202 of the viewer may indicate that the viewer is a six-year-old child. Also, the content viewing information 206 of the profile 202 of the viewer may indicate that the viewer has a preference for watching cartoons. Accordingly, the server 102 may recommend one or more cartoons that are suitable for a six-year-old audience. The foregoing is merely one non-limiting example to illustrate how the profile 202 of the viewer can be used to provide the recommendations of content 310 to the viewer. One of ordinary skill in the art will understand that any of the information included in the profile 202 of the viewer can be utilized to provide the recommendations of content 310 to the viewer.

After the recommended content 310 is provided to the viewer, the consumption rate of content 310 may be monitored. In some configurations, the consumption rate of content 310 may be monitored by the server device (e.g., server 102). In some configurations, the consumption rate of content 310 may be monitored by the client device (e.g., set top box 122). As mentioned above, the concept of ‘rate’ (or, ‘velocity’) refers to the amount of time that the viewer spends viewing content 310 over a particular period of time. In other words, this concept can refer to the ratio of (i) the amount of time that the viewer spends viewing content 310 divided by (ii) a total amount of time. For instance, a viewer that spends eight hours viewing content 310 during a twenty-four hour period of time has a higher consumption rate (or, velocity) of content 310 relative to another viewer that spends four hours viewing content 310 during that twenty-four hour period of time. The current consumption rate of content 310 can be compared to a threshold consumption rate 306 of the content 310.

In some configurations, the threshold consumption rate 306 is based on the profile 202 of the viewer. For example, the threshold consumption rate 306 for watching cartoons may be different for a six-year-old viewer relative to the threshold consumption rate 306 for watching cartoons by a thirty-year-old viewer. As another example, the threshold consumption rate 306 for watching action movies may be different for a six-year-old viewer relative to the threshold consumption rate 306 for watching action movies by a thirty-year-old viewer.

In some configurations, the threshold consumption rate 306 may be dynamic. In other words, the threshold consumption rate 306 may be dynamically adjustable based on various factors, such as any of the information described above with reference to the profile 202 of the viewer. In some configurations, the threshold consumption rate 306 may be preset. In other words, the threshold consumption rate 306 may be preset by an administrator, preset by the viewer, and/or preset by another viewer (e.g., a parental viewer setting the threshold consumption rate 306 for their child).

FIG. 3 illustrates a graph 302 showing an example of the threshold consumption rate 306 in relation to the consumption rate(s) 304, 308 of content 310 at various times (e.g., Time₁, Time₂). In some configurations, the threshold consumption rate 306 of the recommended content 310 can be compared with the current consumption rate of the recommended content 310 in order to determine whether the viewer is engaged in binge watching of the recommended content 310. As described in greater detail above, ‘binge watching’ generally refers to the activity of viewing content 310 for a prolonged, abnormal, and/or otherwise unusually long duration of time. The viewer may engage in binge watching by consuming content 310 at a rate (or, velocity) that exceeds a corresponding threshold consumption rate 306. At Time₁, the consumption rate 308 of content 310 is less than the threshold consumption rate 306 of the content 310. Accordingly, the viewer is not engaged in binge watching at Time₁. However, at Time₂, the consumption rate 304 of content 310 is greater than the threshold consumption rate 306 of the content 310. Accordingly, the viewer is engaged in binge watching at Time₂.

One of ordinary skill in the art will understand that the term ‘content’ may refer to many types of data or media without deviating from the scope of the present disclosure. In some configurations, content 310 may refer to video content. Video content may include video streams, video clips, moving images, motion pictures, and/or other suitable types of media. In some configurations, content 310 may refer to interactive content. Interactive content may include interactive media, multimedia games, video games, and/or any type of game that can be played on a smartphone, tablet computer, laptop computer, desktop computer, set top box, and/or any other suitable type of device. In some configurations, content 310 may refer to audio content. Audio content may include downloaded audio, streamed audio (e.g., streaming radio), and/or any other suitable type of audio data. Additionally or alternatively, content 310 may include various other types of data or media that can be characterized as ‘content’ by one of ordinary skill in the art.

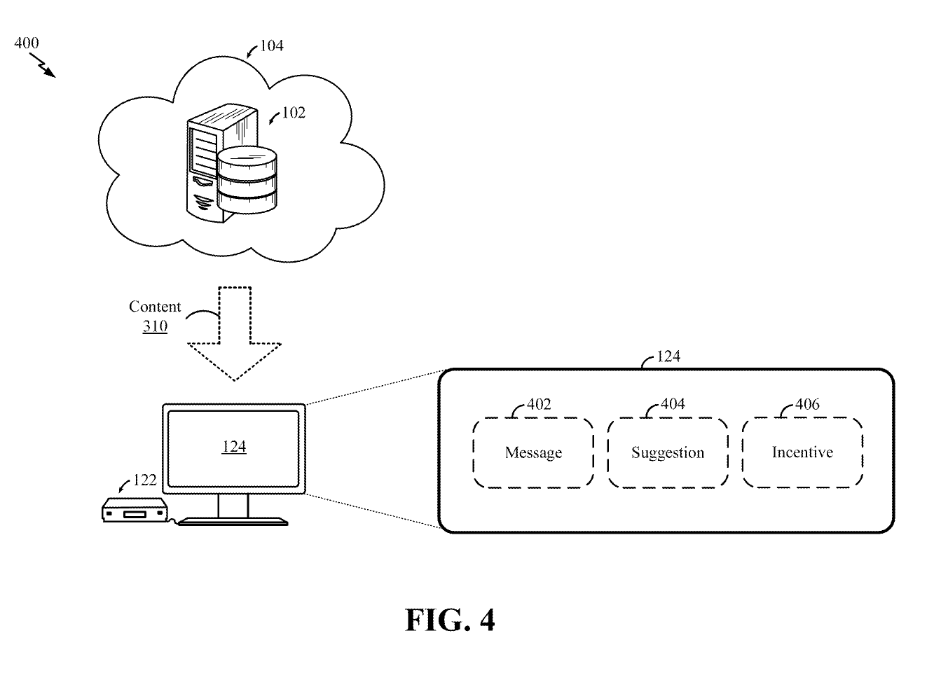

FIG. 4 is a diagram illustrating an example of various operations performed in response to detecting binge watching by the viewer. Although viewers may sometimes engage in binge watching, binge watching can be undesirable under certain circumstances. While binge watching (e.g., watching all of the episodes of a particular show), the viewer is highly engaged with the media system. However, after the binge watching is complete (e.g., all of the episodes of that particular show are watched), the viewer is highly disengaged from the media system. Accordingly, the viewer's engagement with the media system fluctuates between two extremes when binge watching is unregulated. Furthermore, the viewer may not fully realize the massive amount of time consumed while they are engaged in binge watching. For example, the viewer may be so intrigued by a cliffhanger at the end of one episode of a particular show that the viewer is tempted to immediately begin watching the subsequent episode, without fully realizing the total amount of time being consumed for binge watching. Moreover, some media systems automatically begin a subsequent episode following a preceding episode, without any viewer input, which increases the tendency of the viewer to engage in binge watching by the viewer without fully realizing the amount of time being consumed for binge watching. Accordingly, viewers may benefit from enhancements that reduce any undesirable effects associated with binge watching and improve the content viewing experience.

According to various aspects of the present disclosure, the viewer may be limited from further viewing of the recommended content 310 when the viewer is engaged in binge watching. For example, the viewer may be a six-year-old child, and the recommended content 310 may be non-educational cartoons. The six-year-old viewer may eventually engage in binge watching of the non-educational cartoons. Upon detecting that the consumption rate 304 of the non-educational cartoons by the six-year-old viewer exceeds a corresponding threshold consumption rate 306, the six-year-old viewer may be limited from further viewing of the non-educational cartoons.

In some configurations, the viewer may be provided with a message 402 associated with the binge watching. For instance, upon detecting that the consumption rate 304 of the non-educational cartoons by the six-year-old viewer exceeds the corresponding threshold consumption rate 306, the viewer may be provided with a message 402. In some configurations, the message 402 may inform the viewer that he/he is reaching (or, has reached) the threshold consumption rate 306 (or, velocity) for viewing the recommended content 310. In other words, the message 402 may provide the viewer with a notification that their current viewing behavior/pattern meets certain parameters associated with binge watching. In other words, the message 402 may notify the viewer that he/she is engaged in binge watching of the recommended content 310. The message 402 may even indicate the duration, rate, and/or velocity at which the viewer is consuming the recommended content 310. Overall, the message 402 may provide the viewer with an opportunity to evaluate whether he/she wishes to continue binge watching the recommended content 310. In some cases, the viewer may not fully realize how much time has been spent binge watching, and such a message 402 may help the viewer to reconsider their binge watching of the recommended content 310.

In some configurations, the viewer may be provided with a suggestion 404 to view content that is different from the recommended content 310. For example, upon detecting that the consumption rate 304 of non-educational cartoons by the six-year-old viewer exceeds the corresponding threshold consumption rate 306, the viewer may be provided with a suggestion 404 to watch an educational show. In other words, the suggestion 404 may provide the viewer with a suggestion 404 to switch from entertainment-based content to education-based content. This suggestion 404 may be displayed on the display 124 in various forms and configurations without deviating from the scope of the present disclosure.

In some configurations, the viewer may be provided with an incentive 406 for viewing content that is different from the recommended content 310. For example, upon detecting that the consumption rate 304 of the non-educational cartoons by the six-year-old viewer exceeds the corresponding threshold consumption rate 306, the viewer may be provided with an incentive 406 to watch an educational show. Generally, an incentive 406 refers to any form of encouragement, enticement, reason, compensation, discount, point(s), bargain, or other reward to the viewer for taking a particular action (e.g., viewing other content). For instance, the incentive 406 may be that watching one educational show will allow the viewer to watch one non-educational show.

In some configurations, the viewer may be provided with an incentive 406 for performing an activity that is different from viewing content 310. For example, upon detecting that the consumption rate 304 of the non-educational cartoons by the six-year-old viewer exceeds the corresponding threshold consumption rate 306, the viewer may be provided with an incentive 406 to engage in an activity that is different from watching content 310. As described above, an incentive 406 generally refers to any form of encouragement, enticement, reason, compensation, discount, point(s), bargain, or other reward the viewer for taking a particular action (e.g., performing an activity other than viewing content 310). For example, the viewer may be provided with a discount to join a sports team at a local recreation center. As another example, the viewer may be provided with an offer for discounted admission to an amusement park, a water park, a zoo, a carnival, a circus, and/or a fair. As yet another example, the viewer may be provided with a coupon for one or more local restaurants.

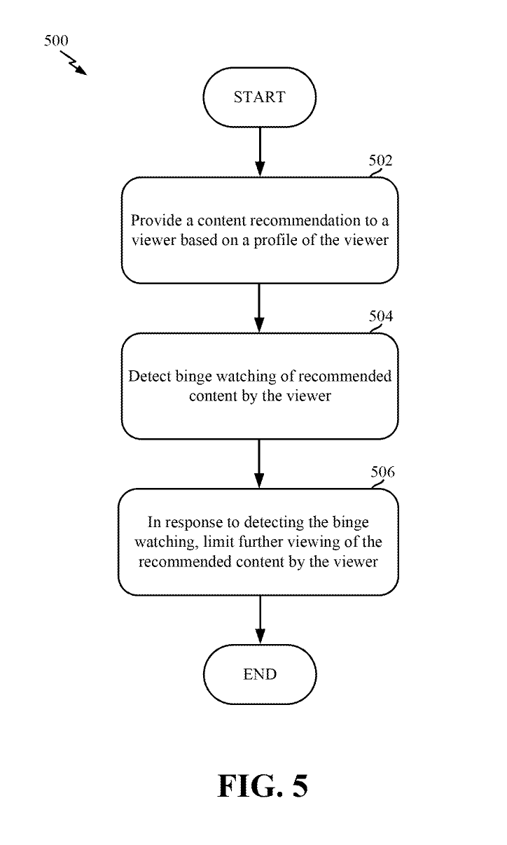

FIG. 5 is a diagram 500 illustrating an example of various methods and/or processes performed by a device. In some configurations, such a device is the server device (e.g., server 102). In some configurations, such a device is the client device (e.g., set top box 122). At block 502, the device may provide a content recommendation to the viewer based on the profile 202 of the viewer. As described in greater detail above with reference to FIG. 2, the profile 202 of the viewer may include various types of information associated with the viewer. In some configurations, the profile 202 may include demographic information 204 associated with the viewer. Demographic information 204 may include the age, gender, geographic location, household income, occupation, ethnicity, language(s), marital status, religious affiliation, and/or other information associated with the viewer. In some configurations, the profile 202 may include content viewing information 206 associated with the viewer. Content viewing information 206 may include any information that pertains to the content viewing habits of the viewer. The profile 202 of the viewer may additionally or alternatively include other information 208 without deviating from the scope of the present disclosure. As described in greater detail above with reference to FIG. 3, the server 102 may provide one or more recommendations of content 310 to the viewer based on the profile 202 of the viewer. For example, referring to FIG. 2, the demographic information 204 of the profile 202 of the viewer may indicate that the viewer is a six-year-old child. Also, the content viewing information 206 of the profile 202 of the viewer may indicate that the viewer has a preference for watching cartoons. Accordingly, the server 102 may recommend one or more cartoons that are suitable for a six-year-old audience.

At block 504, the device may detect binge watching of recommended content by the viewer. In some configurations, the device may detect binge watching by detecting that a consumption of the recommended content by the viewer exceeds a threshold consumption rate of the recommended content. For example, referring to FIG. 3, the device may detect that the current consumption rate 304 (e.g., at Time₂) for watching cartoons exceeds the threshold consumption rate 306 for watching the cartoons.

In some configurations, the threshold consumption rate 306 for watching the recommended content 310 is based on the profile of the viewer. For example, referring to FIG. 3, the threshold consumption rate 306 for watching cartoons may be different for a six-year-old viewer relative to the threshold consumption rate 306 for watching cartoons by a thirty-year-old viewer. As another example, the threshold consumption rate 306 for watching action movies may be different for a six-year-old viewer relative to the threshold consumption rate 306 for watching action movies by a thirty-year-old viewer.

In some configurations, the profile includes information indicating a tendency of binge watching by the viewer. The tendency of binge watching by the viewer is based on content viewing patterns of the viewer. As described in greater detail above with reference to FIGS. 2 and 3, the content viewing information 206 may include indicators associated with the viewer's tendency to engage in binge watching. In some configurations, the threshold consumption rate 306 may be based on the tendency of binge watching by the viewer. If the viewer has a tendency to engage in binge watching, the threshold consumption rate 306 may be adjusted. In some circumstances, the threshold consumption rate 306 may be reduced in order to dissuade the viewer from engaging in further binge watching. In some other circumstances, the threshold consumption rate 306 may be increased to calibrate for the viewer's tendency to view content 310 for a longer period of time (relative to other viewers).

At block 506, the device may limit further viewing of the recommended content by the viewer in response to detecting the binge watching. For example, referring to FIG. 4, the viewer may be a six-year-old child, and the recommended content 310 may be non-educational cartoons. In some circumstances, the six-year-old viewer may engage in binge watching of the non-educational cartoons. Upon detecting that the consumption rate 304 of the non-educational cartoons by the six-year-old viewer exceeds the corresponding threshold consumption rate 306, the six-year-old viewer may be limited from further viewing of the non-educational cartoons.

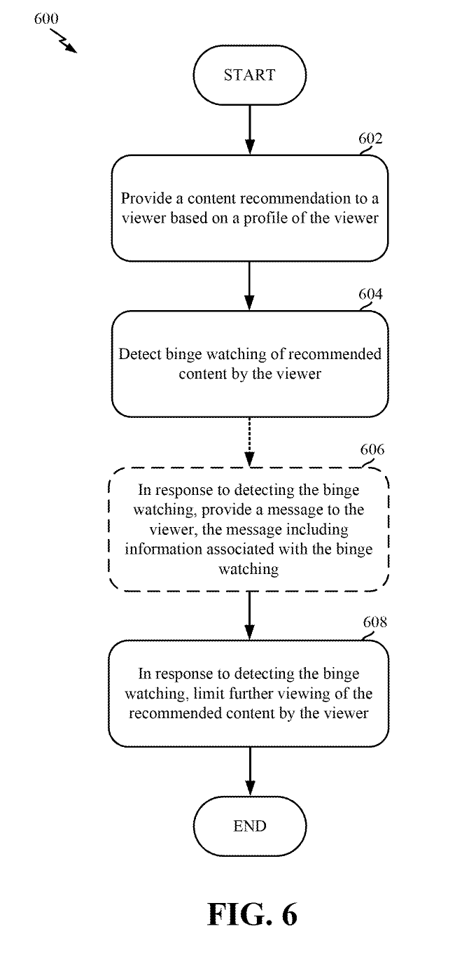

FIG. 6 is a diagram 600 illustrating an example of various methods and/or processes performed by a device. In some configurations, such a device is the server device (e.g., server 102). In some configurations, such a device is the client device (e.g., set top box 122). At block 602, the device may provide a content recommendation to a viewer based on a profile of the viewer. Additional description pertaining to block 602 is provided above with reference to block 502 and therefore will not be repeated. At block 604, the device may detect binge watching of recommended content by the viewer. Additional description pertaining to block 604 is provided above with reference to block 504 and therefore will not be repeated.

In some configurations, at block 606, the device may provide a message to the viewer in response to detecting the binge watching. The message may include information associated with the binge watching. For example, referring to FIG. 4, the viewer may be provided with a message 402 upon detecting that the consumption rate 304 of the non-educational cartoons by the six-year-old viewer exceeds the corresponding threshold consumption rate 306. The message 402 may inform the viewer that he/she is engaged in binge watching. The message 402 may provide the viewer with a notification that their current viewing behavior/pattern meets certain parameters associated with binge watching. The message 402 may even indicate the duration, rate, and/or velocity at which the viewer is consuming content 310. In essence, the message 402 may provide the viewer with an opportunity to evaluate whether they wish to continue binge watching. In some cases, the viewer may not fully realize how much time has been spent binge watching, and such a message 402 may help the viewer to consider ceasing the binge watching. Subsequently, at block 608, the device may limit further viewing of the recommended content by the viewer. Additional description pertaining to block 608 is provided above with reference to block 506 and therefore will not be repeated.

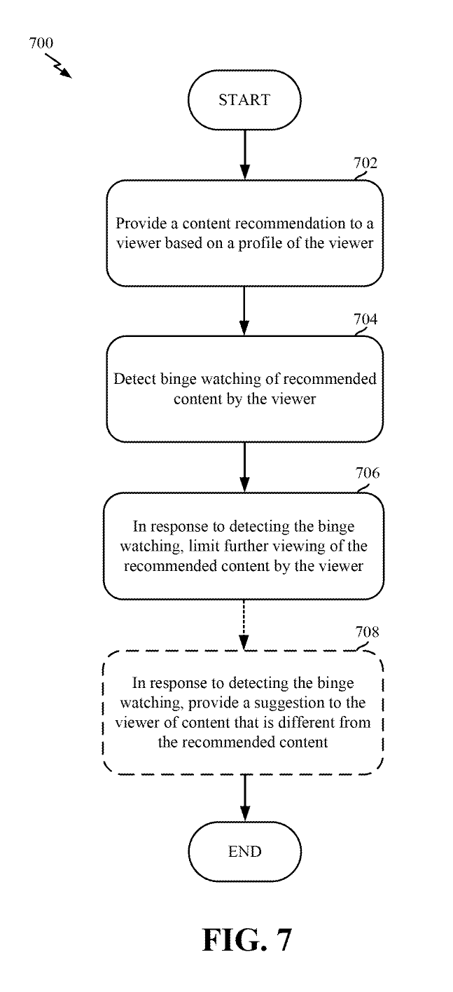

FIG. 7 is a diagram 700 illustrating an example of various methods and/or processes performed by a device. In some configurations, such a device is the server device (e.g., server 102). In some configurations, such a device is the client device (e.g., set top box 122). At block 702, the device may provide a content recommendation to a viewer based on a profile of the viewer. Additional description pertaining to block 702 is provided above with reference to block 502 and therefore will not be repeated. At block 704, the device may detect binge watching of recommended content by the viewer. Additional description pertaining to block 704 is provided above with reference to block 504 and therefore will not be repeated. At block 706, the device may limit further viewing of the recommended content by the viewer. Additional description pertaining to block 706 is provided above with reference to block 506 and therefore will not be repeated.

In some configurations, at block 708, the device may provide a suggestion to the viewer in response to detecting the binge watching. The device may suggest content that is different from the recommended content. As illustrate in FIG. 4, the viewer may receive a suggestion 404 to view content that is different from the recommended content 310. For example, upon detecting that the consumption rate 304 of the non-educational cartoons by the six-year-old viewer exceeds the corresponding threshold consumption rate 306, the viewer may be provided with a suggestion 404 to watch an educational show. In other words, the suggestion 404 may provide the viewer with a suggestion 404 to switch from entertainment-based content to education-based content. This suggestion 404 may be displayed on the display 124 in various forms and configurations without deviating from the scope of the present disclosure.

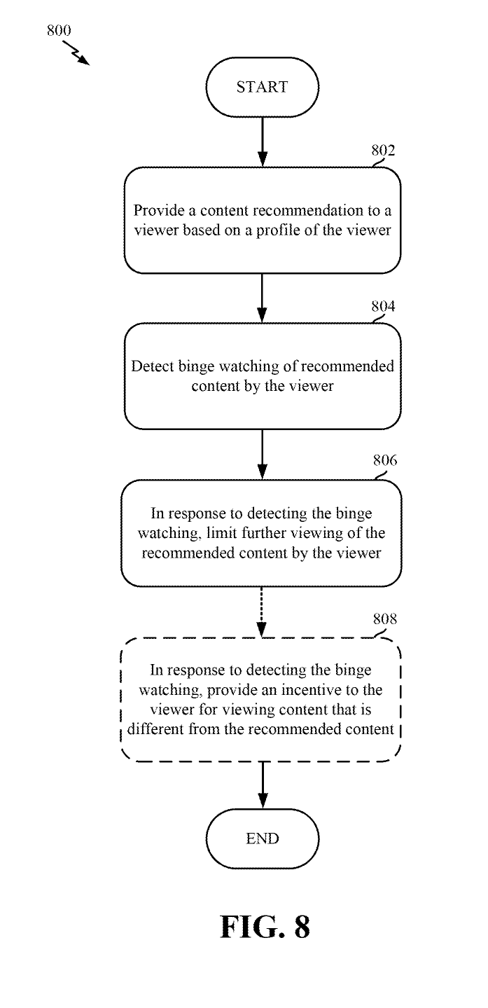

FIG. 8 is a diagram 800 illustrating an example of various methods and/or processes performed by a device. In some configurations, such a device is the server device (e.g., server 102). In some configurations, such a device is the client device (e.g., set top box 122). At block 802, the device may provide a content recommendation to a viewer based on a profile of the viewer. Additional description pertaining to block 802 is provided above with reference to block 502 and therefore will not be repeated. At block 804, the device may detect binge watching of recommended content by the viewer. Additional description pertaining to block 804 is provided above with reference to block 504 and therefore will not be repeated. At block 806, the device may limit further viewing of the recommended content by the viewer. Additional description pertaining to block 806 is provided above with reference to block 506 and therefore will not be repeated.

In some configurations, at block 808, the device may provide an incentive to the viewer in response to detecting the binge watching, and the incentive may be for viewing content different from the recommended content. For example, referring to FIG. 4, the viewer may be provided with an incentive 406 for viewing content that is different from the recommended content 310. For instance, upon detecting that the consumption rate 304 exceeds the corresponding threshold consumption rate 306, the viewer may be provided with an incentive 406 to watch an educational show. As described above, an incentive 406 may refer to any form of encouragement, enticement, reason, compensation, discount, point(s), bargain, or other reward to the viewer for taking a particular action (e.g., viewing other content). For instance, the incentive 406 may be that watching one educational show will allow the viewer to watch one non-educational show.

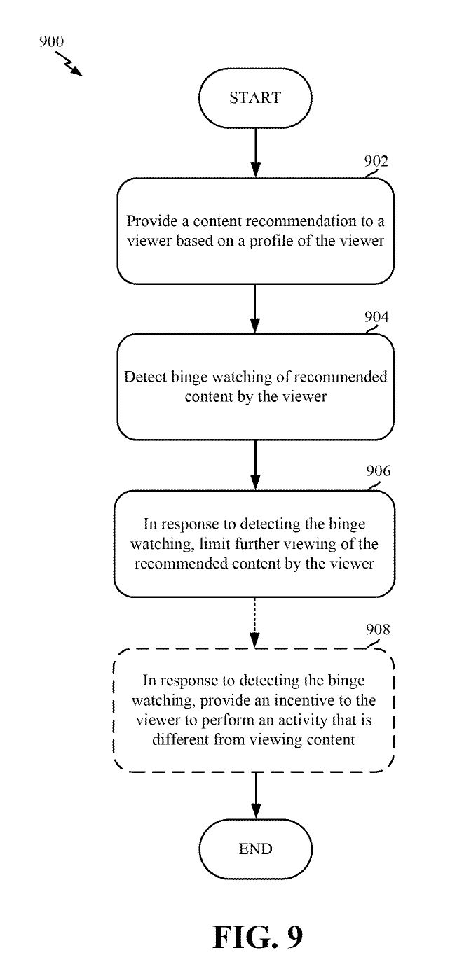

FIG. 9 is a diagram 900 illustrating an example of various methods and/or processes performed by a device. In some configurations, such a device is the server device (e.g., server 102). In some configurations, such a device is the client device (e.g., set top box 122). At block 902, the device may provide a content recommendation to a viewer based on a profile of the viewer. Additional description pertaining to block 902 is provided above with reference to block 502 and therefore will not be repeated. At block 904, the device may detect binge watching of recommended content by the viewer. Additional description pertaining to block 904 is provided above with reference to block 504 and therefore will not be repeated. At block 906, the device may limit further viewing of the recommended content by the viewer. Additional description pertaining to block 906 is provided above with reference to block 506 and therefore will not be repeated.

In some configurations, at block 908, the device may provide an incentive to the viewer in response to detecting the binge watching, and the incentive may be for an activity that is different from viewing content. For example, referring to FIG. 4, the viewer may be provided with an incentive 406 upon detecting that the consumption rate 304 of non-educational cartoons by the six-year-old viewer exceeds the corresponding threshold consumption rate 306. The incentive 406 may be for an activity that is different from watching content 310. For example, the viewer may be provided with a discount to join a sports team at a local recreation center. As another example, the viewer may be provided with an offer for discounted admission to an amusement park, a water park, a zoo, a carnival, a circus, and/or a fair. As yet another example, the viewer may be provided with a coupon for one or more local restaurants.

One of ordinary skill in the art will understand that the sequence and order of operations described herein are provided for illustrative purposes and shall not be construed as a limitation of the present disclosure. The methods and/or processes described with reference to FIGS. 5-9 are provided for illustrative purposes and are not intended to limit the scope of the present disclosure. The methods and/or processes described with reference to FIGS. 5-9 may be performed in sequences different from those illustrated therein without deviating from the scope of the present disclosure. Additionally, some or all of the methods and/or processes described with reference to FIGS. 5-9 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

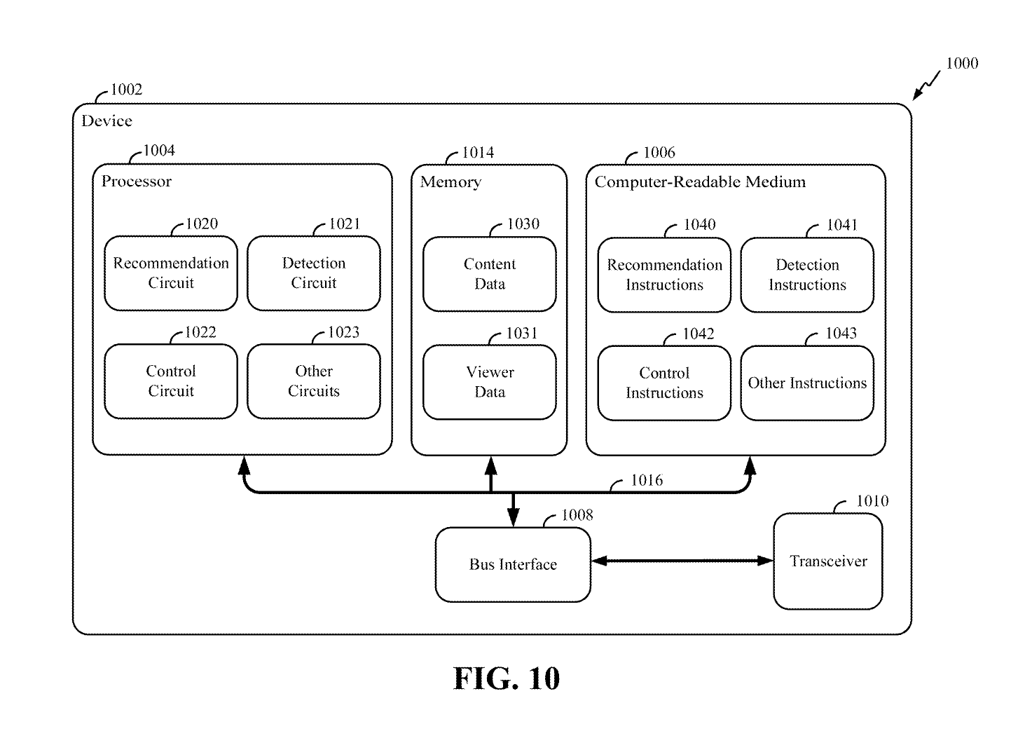

FIG. 10 is a diagram 1000 illustrating an example of a hardware implementation of a device 1002 in accordance with various aspects of the present disclosure. In some configurations, the device 1002 may be the same as the server 102 described in greater detail above. In some configurations, the device may be the same as the set top box 122 described above in greater detail. One of ordinary skill in the art will understand that the device 1002 may be any device configured to according to various aspects of the present disclosure. The device 1002 may include a transceiver 1010. The transceiver 1010 may be configured to receive data and/or transmit data in communication with another apparatus. The transceiver 1010 provides a means for communicating with another apparatus via a wired or wireless transmission medium. The transceiver 1010 may be configured to perform such communications using various types of technologies. One of ordinary skill in the art will understand that many types of technologies may perform such communication without deviating from the scope of the present disclosure. The device 1002 may also include a memory 1014, one or more processors 1004, a computer-readable medium 1006, and a bus interface 1008. The bus interface 1008 may provide an interface between a bus 1016 and the transceiver 1010. The memory 1014, the one or more processors 1004, the computer-readable medium 1006, and the bus interface 1008 may be connected together via the bus 1016. The processor 1004 may be communicatively coupled to the transceiver 1010 and/or the memory 1014.

The processor 1004 may include a recommendation circuit 1020. The recommendation circuit 1020 may include hardware components and/or software algorithms that provide the means for providing a content recommendation to a viewer based on a profile of the viewer. The processor 1004 may also include a detection circuit 1021. The detection circuit 1021 may include hardware components and/or software algorithms that provide the means for detecting binge watching of recommended content by the viewer. In some embodiments, the detection circuit 1021 may include hardware components and/or software algorithms that provide the means for detecting that a consumption rate the recommended content by the viewer exceeds a threshold consumption rate of the recommended content. The processor 1004 may also include a control circuit 1022. The control circuit 1022 may include hardware components and/or software algorithms that provide the means for limiting further viewing of the recommended content by the viewer in response to detecting the binge watching.

In various embodiments, the control circuit 1022 may be configured for various other aspects in relation to binge watching. For example, the control circuit 1022 may include hardware components and/or software algorithms that provide the means for providing a message to the viewer in response to detecting the binge watching, and the message may include information associated with the binge watching. As another example, the control circuit 1022 may include hardware components and/or software algorithms that provide the means for providing a suggestion to the viewer of content that is different from the recommended content in response to detecting the binge watching. As yet another example, the control circuit 1022 may include hardware components and/or software algorithms that provide the means for providing an incentive to the viewer for viewing content that is different from the recommended content in response to detecting the binge watching. As even another example, the control circuit 1022 may include hardware components and/or software algorithms that provide the means for providing an incentive to the viewer to perform an activity that is different from viewing content in response to detecting the binge watching. As another further example, the control circuit 1022 may include hardware components and/or software algorithms that provide the means for providing an incentive to the viewer to perform an activity that is different from viewing content in response to detecting the binge watching.

Although various circuits have been described above, one of ordinary skill in the art will understand that the processor 1004 may also include various other circuits 1023 that are in addition and/or alternative(s) to circuits 1020, 1021, 1022. Such other circuits 1023 may provide the means for performing any one or more of the functions, methods, processes, features and/or aspects described herein. For example, the other circuits 1023 may include hardware components and/or software algorithms that provide the means for transmitting the recommended content. As another example, the other circuits 1023 may include hardware components and/or software algorithms that provide the means for receiving the recommended content.

The computer-readable medium 1006 may include various computer-executable instructions. The computer-executable instructions may include computer-executable code configured to perform various functions and/or enable various aspects described herein. The computer-executable instructions may be executed by various hardware components (e.g., processor 1004) of the device 1002. The computer-executable instructions may be a part of various software programs and/or software modules. The computer-readable medium 1006 may include recommendation instructions 1040. The recommendation instructions 1040 may include computer-executable code for providing a content recommendation to a viewer based on a profile of the viewer. The computer-readable medium 1006 may also include detection instructions 1041. The detection instructions 1041 may include computer-executable code for detecting binge watching of recommended content by the viewer. In some embodiments, the detection instructions 1041 may include computer-executable code for detecting that a consumption rate of the recommended content by the viewer exceeds a threshold consumption rate of the recommended content. The computer-readable medium 1006 may also include control instructions 1042. The control instructions 1042 may include computer-executable code for limiting further viewing of the recommended content by the viewer in response to detecting the binge watching.

In various embodiments, the control instructions 1042 may be configured for various other aspects in relation to binge watching. For example, the control instructions 1042 may include computer-executable code for providing a message to the viewer in response to detecting the binge watching, and the message may include information associated with the binge watching. As another example, the control instructions 1042 may include computer-executable code for providing a suggestion to the viewer of content that is different from the recommended content in response to detecting the binge watching. As yet another example, the control instructions 1042 may include computer-executable code for provide an incentive to the viewer for viewing content that is different from the recommended content in response to detecting the binge watching. As a further example, the control instructions 1042 may include computer-executable code for provide an incentive to the viewer to perform an activity that is different from viewing content in response to detecting the binge watching. As another further example, the control instructions 1042 may include computer-executable code for providing an incentive to the viewer to perform an activity that is different from viewing content in response to detecting the binge watching.

Although various computer-executable instructions have been described above, one of ordinary skill in the art will understand that the computer-readable medium 1006 may also include various other instructions 1043 that are in addition and/or alternative(s) to instructions 1040, 1041, 1042. Such other instructions 1043 may include computer-executable code for performing any one or more of the functions, methods, processes, features and/or aspects described herein. For example, the other instructions 1043 may include computer-executable code for transmitting the recommended content. As another example, the other instructions 1043 may include computer-executable code for receiving the recommended content.

The memory 1014 may include various memory modules. The memory modules may be configured to store, and have read therefrom, various values and/or information by the processor 1004, or any of its circuits 1020, 1021, 1022, 1023. The memory modules may also be configured to store, and have read therefrom, various values and/or information upon execution of the computer-executable code included in the computer-readable medium 1006, or any of its instructions 1040, 1041, 1042, 1043. In some embodiments, the memory 1014 may include content data 1030. The content data 1030 may include any data associated with the content described in greater detail herein. In some embodiments, the memory 1014 may include viewer data. The viewer data 1031 may include any data associated with the viewer (e.g., the profile of the viewer) as described in greater detail herein. The foregoing is an example of some data included in the memory 1014 of the device 1002. One of ordinary skill in the art will understand that the memory 1014 may also include various other data (not shown) that is in addition and/or alternative to the aforementioned data 1030, 1031. Such other data (not shown) may include data performing any one or more of the functions, methods, processes, features and/or aspects described herein.

One of ordinary skill in the art will also understand that the device 1002 may include alternative and/or additional features without deviating from the scope of the present disclosure. In accordance with various aspects of the present disclosure, an element, or any portion of an element, or any combination of elements may be implemented with a processing system that includes one or more processors 1004. Examples of the one or more processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system may be implemented with a bus architecture, represented generally by the bus 1016 and bus interface 1008. The bus 1016 may include any number of interconnecting buses and bridges depending on the specific application of the processing system and the overall design constraints. The bus 1016 may link together various circuits including the one or more processors 1004, the memory 1014, and the computer-readable media 1006. The bus 1016 may also link various other circuits such as timing sources, peripherals, voltage regulators, and power management circuits, which are well known in the art.

The one or more processors 1004 may be responsible for managing the bus 1016 and general processing, including the execution of software stored on the computer-readable medium 1006. The software, when executed by the one or more processors 1004, causes the processing system to perform the various functions described below for any one or more apparatuses. The computer-readable medium 1006 may also be used for storing data that is manipulated by the one or more processors 1004 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1006. The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may also include, by way of example, a carrier wave, a transmission line, and any other suitable medium for transmitting software and/or instructions that may be accessed and read by a computer. The computer-readable medium 1006 may reside in the processing system, external to the processing system, or distributed across multiple entities including the processing system. The computer-readable medium 1006 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

The foregoing description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for providing content to a viewer, the method comprising:
providing a content recommendation to a viewer based on a profile of the viewer;
detecting binge watching of recommended content by the viewer; and
in response to detecting the binge watching, limiting further viewing of the recommended content by the viewer.

2. The method of claim 1, further comprising:
in response to detecting the binge watching, providing a message to the viewer, the message comprising information associated with the binge watching.

3. The method of claim 1, further comprising:
in response to detecting the binge watching, providing a suggestion to the viewer of content that is different from the recommended content.

4. The method of claim 1, further comprising:
in response to detecting the binge watching, providing an incentive to the viewer for viewing content that is different from the recommended content.

5. The method of claim 1, further comprising:
in response to detecting the binge watching, providing an incentive to the viewer to perform an activity that is different from viewing content.

6. The method of claim 1, wherein the detecting the binge watching comprises:
detecting that a consumption rate of the recommended content by the viewer exceeds a threshold consumption rate of the recommended content.

7. The method of claim 6, wherein the threshold consumption rate of the recommended content is based on the profile of the viewer.

8. The method of claim 7, wherein the profile comprises information indicating a tendency of binge watching by the viewer.

9. The method of claim 8, wherein the tendency of binge watching by the viewer is based on content viewing patterns of the viewer.

10. The method of claim 1, further comprising:
transmitting the recommended content.

11. The method of claim 1, further comprising:
receiving the recommended content.

12. An apparatus for providing content to a viewer, the apparatus comprising:
at least one processor;
a memory containing a set of instructions when executed by the at least one processor perform operations comprising:
providing a content recommendation to a viewer based on a profile of the viewer;
detecting binge watching of recommended content by the viewer; and
in response to detecting the binge watching, limiting further viewing of the recommended content by the viewer.

13. The apparatus of claim 12, wherein the set of instructions when executed by the at least one processor perform the operations further comprising:
in response to detecting the binge watching, providing a message to the viewer, the message comprising information associated with the binge watching.

14. The apparatus of claim 12, wherein the set of instructions when executed by the at least one processor perform the operations further comprising:
in response to detecting the binge watching, providing a suggestion to the viewer of content that is different from the recommended content.

15. The apparatus of claim 12, wherein the set of instructions when executed by the at least one processor perform the operations further comprising:
in response to detecting the binge watching, providing an incentive to the viewer for viewing content that is different from the recommended content.

16. The apparatus of claim 12, wherein the set of instructions when executed by the at least one processor perform the operations further comprising:
in response to detecting the binge watching, providing an incentive to the viewer to perform an activity that is different from viewing content.

17. The apparatus of claim 12, wherein the detecting the binge watching comprises:
detecting that a consumption rate of the recommended content by the viewer exceeds a threshold consumption rate of the recommended content.

18. The apparatus of claim 17, wherein the threshold consumption rate of the recommended content is based on the profile of the viewer.

19. The apparatus of claim 18, wherein the profile comprises information indicating a tendency of binge watching by the viewer.

20. The apparatus of claim 19, wherein the tendency of binge watching by the viewer is based on content viewing patterns of the viewer.

21. The apparatus of claim 12, further comprising a transceiver, wherein the set of instructions when executed by the at least one processor perform the operations further comprising:
utilizing the transceiver to transmit the recommended content.

22. The apparatus of claim 12, further comprising a transceiver, wherein the set of instructions when executed by the at least one processor perform the operations further comprising:
utilizing the transceiver to receive the recommended content.

23. An apparatus for providing content to a viewer, the apparatus comprising:
means for providing a content recommendation to a viewer based on a profile of the viewer;
means for detecting binge watching of recommended content by the viewer; and
means for limiting further viewing of the recommended content by the viewer in response to detecting the binge watching.

24. The apparatus of claim 23, further comprising:
means for providing, in response to detecting the binge watching, a message to the viewer, the message comprising information associated with the binge watching.

25. The apparatus of claim 23, further comprising:
means for providing, in response to detecting the binge watching, a suggestion to the viewer of content that is different from the recommended content.

26. The apparatus of claim 23, further comprising:
means for providing, in response to detecting the binge watching, an incentive to the viewer for viewing content that is different from the recommended content.

27. The apparatus of claim 23, further comprising:
means for providing, in response to detecting the binge watching, an incentive to the viewer to perform an activity that is different from viewing content.

28. The apparatus of claim 23, wherein the means for detecting the binge watching is configured for detecting that a consumption rate of the recommended content by the viewer exceeds a threshold consumption rate of the recommended content.

29. The apparatus of claim 28, wherein the threshold consumption rate of the recommended content is based on the profile of the viewer.

30. The apparatus of claim 29, wherein the profile comprises information indicating a tendency of binge watching by the viewer.

31. The apparatus of claim 30, wherein the tendency of binge watching by the viewer is based on content viewing patterns of the viewer.

32. The apparatus of claim 23, further comprising:
means for transmitting the recommended content.

33. The apparatus of claim 23, further comprising:
means for receiving the recommended content.

34. A computer-readable medium comprising computer-executable code for:
providing a content recommendation to a viewer based on a profile of the viewer;
detecting binge watching of recommended content by the viewer; and
in response to detecting the binge watching, limiting further viewing of the recommended content by the viewer.

35. The computer-readable medium of claim 34, wherein the computer-executable code is further for:
in response to detecting the binge watching, providing a message to the viewer, the message comprising information associated with the binge watching.

36. The computer-readable medium of claim 34, wherein the computer-executable code is further for:
in response to detecting the binge watching, providing a suggestion to the viewer of content that is different from the recommended content.

37. The computer-readable medium of claim 34, wherein the computer-executable code is further for:
in response to detecting the binge watching, providing an incentive to the viewer for viewing content that is different from the recommended content.

38. The computer-readable medium of claim 34, wherein the computer-executable code is further for:
in response to detecting the binge watching, providing an incentive to the viewer to perform an activity that is different from viewing content.

39. The computer-readable medium of claim 34, wherein the detecting the binge watching comprises:
detecting that a consumption rate of the recommended content by the viewer exceeds a threshold consumption rate of the recommended content.

40. The computer-readable medium of claim 39, wherein the threshold consumption rate of the recommended content is based on the profile of the viewer.

41. The computer-readable medium of claim 40, wherein the profile comprises information indicating a tendency of binge watching by the viewer.

42. The computer-readable medium of claim 41, wherein the tendency of binge watching by the viewer is based on content viewing patterns of the viewer.

43. The computer-readable medium of claim 34, wherein the computer-executable code is further for:
transmitting the recommended content.

44. The computer-readable medium of claim 34, wherein the computer-executable code is further for:
receiving the recommended content.
